(19) United States
(12) Patent Application Publication
(10) Pub. No.: US 2009/0139939 A1
(43) Pub. Date: Jun. 4, 2009

(54) Method & Apparatus for Steam Backwashing a Filter Assembly

(76) Inventors: Steven P. Franke, Nowata, OK (US); William B. Frauenberger, Nowata, OK (US); Michael J. Morgan, Nowata, OK (US)

Correspondence Address: STINSON MORRISON HECKER LLP;ATTN: PATENT GROUP, 1201 WALNUT STREET, SUITE 2800, KANSAS CITY, MO, 64106-2150, US

(21) Appl. No.: 11/950,151

(22) Filed: Dec. 4, 2007

(51) Int. Cl. B01D 29/62; B01D 37/04

(52) U.S. Cl. 210/798; 210/411

(57) ABSTRACT

A method for steam backwashing a filter assembly. The filter assembly has a housing for receiving contaminated liquid and discharging filtered liquid, a filter positioned within the housing for filtering the contaminated liquid, and a drain coupled with the housing. Steam is sent through the housing to remove contaminants from the filter without draining the contaminated liquid or the filtered liquid from the housing. The steam forces the contaminated liquid, the filtered liquid and the contaminants through the drain.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention relates to a filter assembly, and more particularly, to a method and apparatus for backwashing a filter assembly of the type used in hydrocarbon refining applications.

2. Description of Related Art

Hydrocarbons such as gas oil (residuum or distillate) must be filtered before undergoing processes such as hydrocracking, hydrodesulfurizing and hydrotreating. Solid contaminants, such as iron oxide, coke fines, formation sand and catalyst, commonly present within liquid hydrocarbons can damage the catalyst load necessary to carry out the above processes. The expense of replacing the catalyst load is much greater than the expense of filtering the contaminants from the liquid. Further, filtering the liquid has environmental benefits.

A typical hydrocarbon filter system may have one or more filter arrays coupled in parallel. Each filter array typically has one or more filter assemblies with an inlet for receiving contaminated liquid and an outlet for discharging filtered liquid. Each filter assembly typically contains a plurality of vertical filter elements. Over time, the filter elements become clogged with the solid contaminants causing a pressure differential between the inlet and outlet. Each filter assembly is typically backwashed to clean the filter elements.

A typical backwash consists first of stopping the flow of liquid into one of the filter arrays. Next, a reverse flow of liquid hydrocarbons is sent through each filter assembly in the filter array. The hydrocarbon flow may be either the filtered liquid, or a different liquid. The reverse liquid flow dislodges solids from the filter elements and flushes the solids through a drain that is opened at the beginning of the backwash process. It is also known to send steam through the system either before or after backwashing with liquid. The steam further cleans the filter assemblies. After backwashing, the drain is closed, the inlet is opened and filtering resumes.

Another method of backwashing diverts some of the process liquid into a holding tank. The liquid is heated creating a pocket of compressed gas above the liquid. When a filter assembly needs backwashing, the inlet and outlet are closed, the filter assembly is drained and the heated liquid and gas are released in reverse through the system. The gas forces the process liquid through the assembly. The gas also helps to dislodge solids from the filter elements within the filter assembly.

Each of the above mentioned known backwash processes require backwashing the system with liquid. Diverting process liquid for backwashing results in a reduction in the overall outlet pressure of filtered liquid discharged from the filtering system. This pressure reduction is undesirable because it wastes process liquid and reduces the overall volumetric flow rate of the system. Additionally, the above mentioned processes do not adequately remove solids from the filter elements. Further, only one filter assembly within a filter array may be backwashed at a time using the above mentioned processes.

### BRIEF SUMMARY OF THE INVENTION

The present invention is a method for steam backwashing a filter assembly having a housing for receiving contaminated liquid and discharging filtered liquid, a filter positioned within the housing for filtering the contaminated liquid and a drain coupled with the housing. The steam backwashing method comprises sending steam through the housing without draining the contaminated liquid or the filtered liquid from the housing so that the steam removes contaminants from the filter and forces the contaminated liquid, the filtered liquid and the contaminants through the drain.

The present invention also encompasses a filter assembly adapted for steam backwashing. The filter assembly has a housing, a filter positioned within the housing, and a steam valve and drain each coupled with the housing. The housing has an inlet for receiving contaminated liquid and an outlet for discharging filtered liquid. The filter is configured to allow the liquid to flow from the inlet through the filter and toward the outlet. The steam valve regulates steam flow into the housing for backwashing the filter without draining the contaminated liquid or the filtered liquid from the housing. The housing is configured to allow the steam to flow from the outlet through the filter to remove contaminants from the filter. The drain is configured for receiving the contaminated liquid, the filtered liquid and the contaminants forced through the drain by the steam.

The present invention is advantageous because no process liquid is diverted from the system for backwashing the filter assemblies. Therefore, there is no pressure reduction in the overall outlet pressure of the system due to the backwashing. Further, the process also cleans the filter assemblies better than the prior art. Because the filter assembly contains process liquid (contaminated and filtered) when the steam is sent through it, the liquid carries away contaminants dislodged by the steam. The process may also be carried out more quickly than the prior art because two filter assemblies within a filter array may be backwashed at the same time.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 is a top plan view of a filter array according to an embodiment of the present invention;

FIG. 2 is a side elevational view of a the filter array of FIG. 1;

FIG. 3 is a front elevational view of the filter array of FIG. 1;

FIG. 4 is a schematic view, with portions broken away of the filter array of FIG. 1;

FIG. 5 is a side cross-sectional view, with portions broken away, of one of the filter assemblies shown in FIG. 1; and

FIG. 6 is an enlarged view of a portion of the top of the filter assembly shown in FIG. 5.

### DETAILED DESCRIPTION OF PREFERRED EMBODIMENT

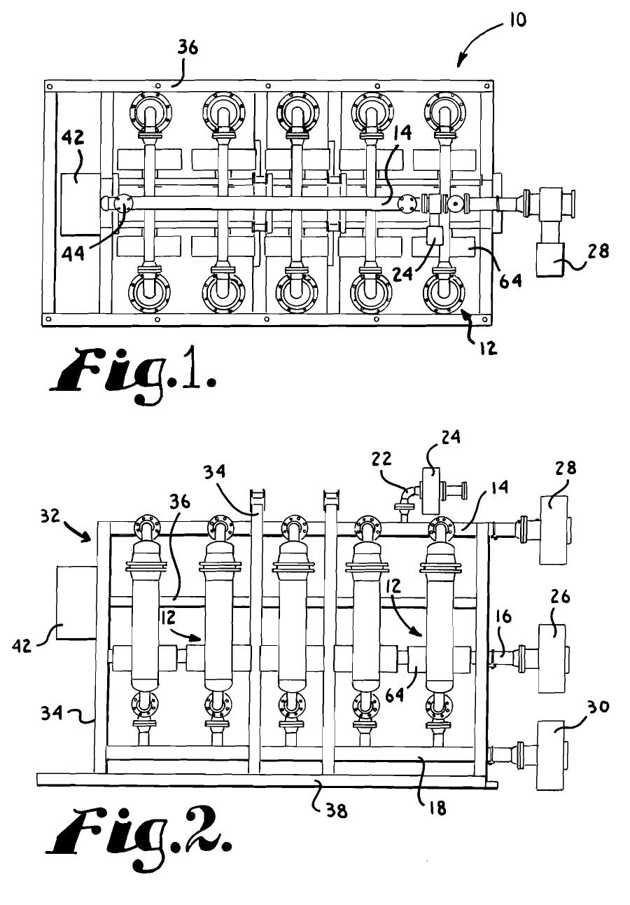

Referring initially to FIG. 1, a filter array is designated generally by the numeral 10. The filter array has two parallel rows each containing five vertically mounted and substantially identical filter assemblies 12. Referring now to FIG. 2, each filter assembly is mounted between an outlet header line 14 located at the top end of the filter assemblies and an inlet line 16 located substantially at the opposite end of the filter assemblies. A backwash drain line 18 is positioned underneath the inlet line. A cross pipe 20, one of which is shown in FIG. 3, couples each filter assembly 12 with inlet line 16 and backwash drain line 18. The inlet line, outlet header line and backwash drain line are in liquid communication with each filter assembly. There is a pressure differential gauge (not shown) coupled with the inlet and outlet lines for determining when it is necessary to steam backwash the filter assemblies. Filter array 10 may be coupled in parallel to other filter arrays (not shown) for filtering contaminated liquid at a high volumetric flow rate. In such a configuration, one filter array may be closed off from the system for backwashing, while the other filter arrays continue to filter process liquid. This arrangement allows for continuous liquid flow.

As shown in FIG. 2, a steam inlet line 22 is coupled with the outlet header line. A steam valve 24 is coupled with the steam inlet line for regulating steam flow through the system. An inlet valve 26 is coupled with the inlet line for regulating the flow of contaminated liquid into the system, and an outlet valve 28 is coupled with the outlet header line for regulating the flow of filtered liquid out of the system. A main drain valve 30 is coupled with the backwash drain line for regulating the flow of liquid through the drain line. A receiving vessel (not shown) is coupled with the backwash drain line for receiving contaminants and liquid backwashed through the system by steam. The receiving vessel has a vent (not shown) for releasing steam. The steam valve and main drain valve are preferably pneumatic actuated ball valves which fail in the closed position, but other types of valves are within the scope of the invention. Additionally, the inlet valve and outlet valve are preferably pneumatic actuated ball valves which fail in the open position, but other types of valves are within the scope of the invention. An air line (not shown) is coupled with each valve and each valve also preferably comprises a solenoid for actuating the valve.

The entire assembly is mounted on a framework designated generally by the numeral 32 shown in FIG. 2. The framework includes parallel vertical supports 34, horizontal supports 36 and a bottom platform 38. Each filter assembly 12 is mounted to a horizontal support 36 as shown in FIG. 3. Also as shown in FIG. 3, at least two of the vertical supports have eyelets 40 at the top of the filter array which may be utilized for transport. A controller 42, shown in FIG. 2, is mounted at one end of the framework for controlling valve timing during the backwash process. The controller is electrically coupled with the differential pressure gauge (not shown) and the solenoid (not shown) of each valve. There is also a vent 44 on the outlet header line, shown in FIG. 1, for preventing unsafe pressure levels from building up within the system.

Referring now to FIG. 3 and details of construction of the filter assemblies 12, each filter assembly has a cylindrical housing 46 with an inlet 48 for receiving contaminated liquid and an outlet 50 for discharging filtered liquid. Inlet 48 is coupled with an elbow 52 which is coupled with a link 54 via a flanged coupling 56. Link 54 is in turn coupled with cross pipe 20 via a flanged coupling 58. Each cross pipe is coupled with inlet line 16 via a flanged coupling 60, and backwash drain line 18 via a flanged coupling 62. A housing drain valve 64, shown in FIG. 2, is coupled with link 54, and extends upwardly from the link. Acting together, the housing drain valves allow isolation of individual housings during backwashing. Link 54 and housing drain valve 64 are preferably an integral pneumatic actuated ball valve having flanged ends, but other types of valves are within the scope of the invention.

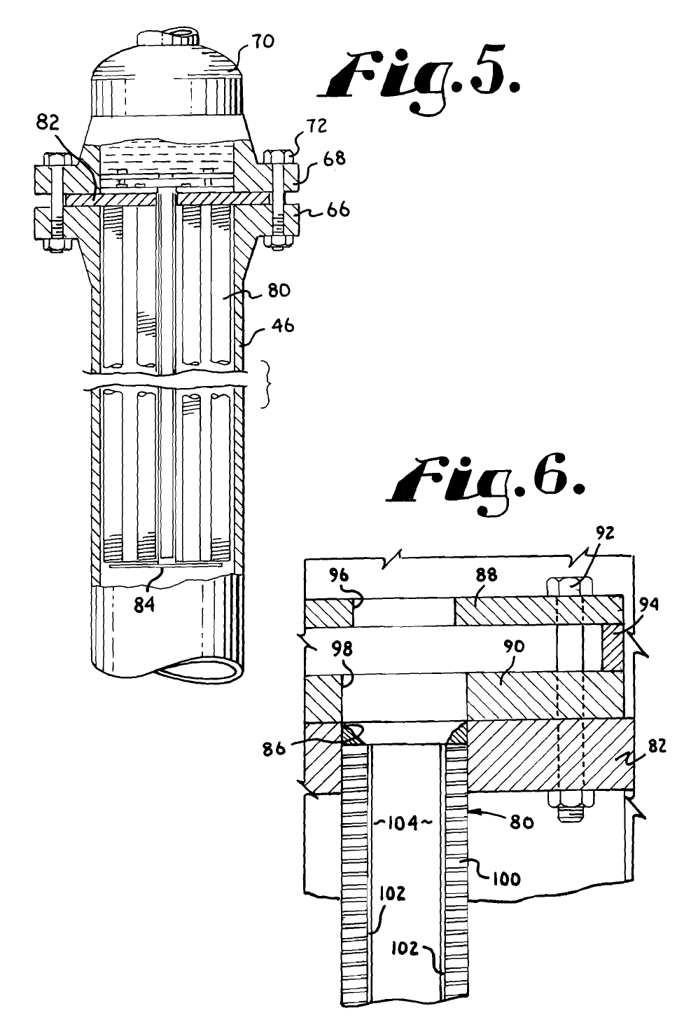

Referring now to FIG. 3, the outlet of each filter assembly is surrounded by a flange 66, which is aligned with a corresponding flange 68 on a generally bell-shaped header 70. Flanges 66 and 68 are held in alignment by a plurality of nut and bolt assemblies 72, shown in FIG. 5. Header 70 receives an elbow 74, shown in FIG. 3, which is coupled with an outlet link 76 via a flange coupling 78. Outlet link 76 is coupled with outlet header line 14.

As shown in FIG. 5, a plurality of individual filter stalks 80 are positioned within each housing. The top of each filter stalk is fixedly attached to an assembly flange 82 which is positioned between cylinder 46 and bell-shaped header 70. The opposite end of each filter stalk is supported by a support plate 84. Assembly flange 82 has an opening 86, one of which is shown in FIG. 6, corresponding to each filter stalk 80 for allowing filtered liquid and steam to flow through the flange. First and second diffuser plates 88, 90 are secured to assembly flange 82 via nut and bolt assemblies, one of which is shown as 92 in FIG. 6. A ring 94 spaces the first and second diffuser plates. The first diffuser plate has an opening 96 and the second diffuser plate has an opening 98 larger than opening 96. The size difference between the two openings allows a pressure differential to develop which evenly distributes the backwash steam among the individual filter stalks.

Preferably, each filter stalk is a profile wire screen which comprises a metal filter media 100, shown in FIG. 6, fixedly attached to a number of media supports 102 extending the length of the stalk. The filter media 100 contains a plurality of slots or perforations through which liquid may pass but not solids of a predetermined size or larger. The filter media 100 is formed such that the filter stalk is cylindrical with a central open area 104. The filter stalks are positioned within the housing such that they allow liquid to flow from inlet 48 through the slots in the filter and toward outlet 50. Although a profile wire screen filter media is shown, it is within the scope of the invention for each filter stalk to be constructed from a perforated tube, or a mesh or weave of metal, polymeric material or cloth.

In operation, the filter array filters a contaminated liquid. The contaminated liquid enters the array through inlet valve 30, shown in FIG. 2, and flows through inlet line 18. The contaminated liquid flows from inlet line 18 into each pipe cross 20, link 54, elbow 52 and housing 46, shown in FIG. 3. Once inside a housing, the liquid flows through the slots or perforations in each filter stalk 80 into central open area 104 of the filter stalk, shown in FIG. 6. The contaminants within the liquid are too large to flow through the slots in the filter stalks and thus remain within the housing outside the stalks. The filtered liquid flows upward through the filter stalks and through the openings in assembly flange 82 and first and second diffuser plates 88, 90. The filtered liquid then flows through header 70, elbow 74 and outlet link 76 on its way to outlet header line 14, shown in FIG. 3. The filtered liquid flows through the open outlet valve 28, shown in FIG. 2, to the next process step.

Over time the contaminants within the housing begin to plug up the slots in the filter media. When the pressure differential between the inlet line and the outlet header line reaches a predetermined difference as measured by the pressure differential gauge (not shown), the controller begins the process of backwashing the filter array. The pressure differential at which backwashing begins is preferably between 10 to 50 pounds per square inch and most preferably about 30 pounds per square inch. Alternatively, or in conjunction with utilizing pressure differential to initiate backwashing, the system may initiate backwashing at predetermined time intervals, or by engagement of a manual start button (not shown) on the controller.

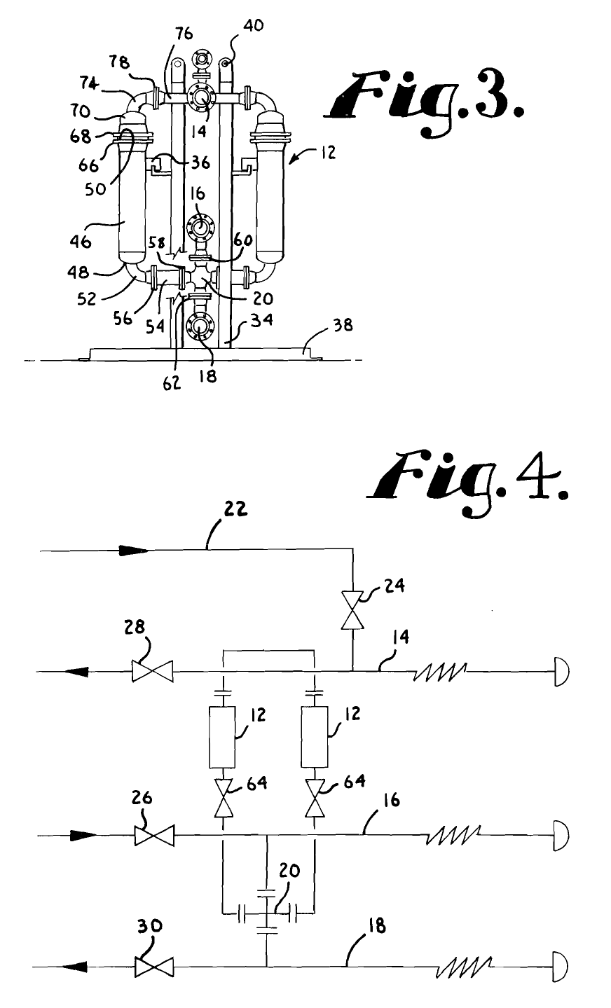

Referring now to FIG. 4, at the beginning of the backwash process, the controller closes the inlet valve 26 and the outlet valve 28 to stop the flow of contaminated liquid into the housing. The controller closes all of the housing drain valves 64 either simultaneously therewith or shortly thereafter. Approximately two seconds later the controller opens the main drain valve 30 and the steam valve 24 simultaneously. At this time each housing is full with process liquid. Approximately two seconds later the controller opens one of the housing drain valves 64 to backwash the filter assembly 12 coupled with the open valve. The open steam valve 24 sends steam through the outlet header line 14 and into each filter stalk of the assembly 12 with the open drain valve without draining the contaminated liquid and the filtered liquid from the housing. The steam passes outlet link 76, elbow 74, header 70, and the openings in assembly plate 82 and first and second diffuser plates 88, 90 on its way to each filter stalk within the assembly, as shown in FIG. 3. Once inside the filter stalks 80, the steam simultaneously forces the contaminated liquid and the filtered liquid remaining within housing 46 down through the inlet 48 and also cleans contaminants from each filter stalk and the interior housing walls by flowing through the stalks in the opposite direction as the contaminated liquid. The contaminants which are cleaned from the filter stalks and housing are carried out of the housing by the contaminated liquid and the filtered liquid that were inside the housing at the start of backwashing. The contaminated liquid, filtered liquid and contaminants travel through elbow 52, link 54, pipe cross 20 and backwash drain line 18 on its way to the receiving vessel (not shown). After the contaminated liquid, filtered liquid and contaminants are forced from the housing, the steam flows through the housing at a higher velocity than when the contaminated liquid and filtered liquid are within the housing. This high velocity steam flows through the housing for a predetermined amount of time for further cleaning of the filter stalks. Any steam which flows into the receiving vessel exits through the vent in the vessel.

After the filter stalks in the housing are cleaned, the controller closes the housing drain valve 64, shown in FIG. 4, and the next housing drain valve is opened for steam backwashing the filter stalks in the next housing in the manner described above. Each housing drain valve is preferably open for about 10 to 30 seconds and most preferably for about 15 seconds. After each housing has been backwashed by steam, the steam valve 24 is closed to stop steam flowing through the housings and the main drain valve 30 closes to stop the flow of liquid through the backwash drain line. Approximately two seconds later the controller opens all of the housing drain valves 64 to allow liquid to flow through each housing. Finally, approximately two seconds later the controller opens outlet valve 28 and inlet valve 26 to allow contaminated process liquid to enter the housings and filtered liquid to exit the housings.

The array preferably filters a hydrocarbon process liquid (e.g. gas oil, residuum or distillate) from contaminants such as iron oxide, coke fines, formation sand and catalyst, but it is within the scope of the invention for the array to filter other types of contaminants from other types of liquids. The process liquid's operating temperature is preferably between 150 to 750 degrees Fahrenheit, and the operating pressure is preferably between 35 to 1500 pounds per square inch gauge. The temperature of the steam backwash is preferably between 250 to 750 degrees Fahrenheit, and most preferably between 350 to 550 degrees Fahrenheit. The pressure of the steam backwash is preferably between 50 to 300 pounds per square inch gauge, and most preferably between 150 to 175 pounds per square inch gauge. The volumetric flow rate of the steam backwash is preferably between 10 to 100 standard cubic feet per minute, and most preferably between 25 to 50 standard cubic feet per minute.

During the backwashing process, none of the process liquid (contaminated or filtered) is diverted or otherwise used to backwash the housings and filter stalks, before or after the steam backwashes the housings. Therefore, if the filter array is coupled in parallel with other arrays there is no reduction in the overall filtered process liquid outlet pressure beyond that caused by taking the single filter array offline for backwashing. Also, the process liquid (filtered and contaminated) that is in each housing is not drained from the housing before the steam backwashing begins. To the contrary, the contaminated liquid and filtered liquid remaining within the housing carry out the contaminants which are cleaned from the filter stalks and housing by the steam backwash.

Although, the steam backwashing is described above as acting on one housing at a time, it is within the scope of the invention for more than one housing to be backwashed at a time. For instance, if a high volumetric flow rate of steam is sent through the system, two or more housings in a single filter array may be backwashed simultaneously.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

What is claimed and desired to be secured by Letters Patent is as follows:

1. A method for steam backwashing a filter assembly, said filter assembly comprising a housing for receiving contaminated liquid and discharging filtered liquid, a filter positioned within said housing for filtering said contaminated liquid, and a drain coupled with said housing, said method comprising:
sending steam through said housing without draining said contaminated liquid or said filtered liquid from said housing, wherein said steam removes contaminants from said filter and forces said contaminated liquid, said filtered liquid and said contaminants through said drain.

2. The method of claim 1, further comprising stopping the flow of contaminated liquid into said housing before sending steam through said housing.

3. The method of claim 2, wherein said filter assembly further comprises a plurality of housings coupled in parallel for filtering said contaminated liquid, wherein a filter is positioned within each housing, and a drain is coupled with each housing, and wherein said method further comprises sending steam through each of said housings one at a time after stopping the flow of contaminated liquid into said plurality of housings.

4. The method of claim 3, further comprising:
stopping said steam flow through said plurality of housings; and
resuming the flow of contaminated liquid into said plurality of housings for filtering.

5. The method of claim 1, wherein said filter assembly further comprises an inlet valve coupled with said housing for regulating the contaminated liquid flow into said housing, an outlet valve coupled with said housing for regulating the filtered liquid flow out of said housing, a steam valve coupled with said housing for regulating the steam flow into said housing and a main drain valve coupled with said drain for regulating the flow through said drain, said method further comprising:
closing said inlet valve and said outlet valve;
opening said main drain valve after closing said inlet valve and said outlet valve; and
opening said steam valve to send steam through said housing.

6. The method of claim 5, wherein said filter assembly further comprises a plurality of housings coupled in parallel with said inlet valve, said outlet valve, said steam valve, and said drain, and said filter assembly further comprising a plurality of housing drain valves each coupled with one of said housings between said housing and said main drain valve, wherein said plurality of housing drain valves provide backwashing isolation for each of said housings, said method further comprising:
closing each of said housing drain valves before opening said main drain valve;
opening one of said housing drain valves after opening said steam valve;
closing said open housing drain valve; and
repeating the steps of opening and closing one of said housing drain valves until each filter has been backwashed with steam.

7. The method of claim 6, further comprising:
closing said main drain valve and said steam valve after said contaminated liquid, said filtered liquid and said contaminants are drained from each of said filter housings;
opening each of said housing drain valves; and
opening said inlet valve and said outlet valve to resume filtering contaminated liquid.

8. The method of claim 1, wherein none of said contaminated liquid is diverted for backwashing said filter assembly and none of said filtered liquid is diverted for backwashing said filter assembly.

9. The method of claim 1, wherein liquid does not backwash said filter assembly after sending said steam through said housing.

10. The method of claim 1, wherein said steam flows through said housing with a greater velocity after said contaminated liquid and said filtered liquid are drained from said housing.

11. The method of claim 1, wherein said steam flows through said housing in the opposite direction that the contaminated liquid flows through said housing.

12. The method of claim 1, wherein said contaminated liquid is a hydrocarbon.

13. The method of claim 1, wherein said steam flows through said housing at a rate of between about 10 to 100 standard cubic feet per minute.

14. The method of claim 1, wherein said steam is at a pressure of between about 50 to 300 pound-force per square inch gauge.

15. The method of claim 1, wherein said steam is at a temperature of between about 250 to 750 degrees Fahrenheit.

16. A filter assembly adapted for steam backwashing, said filter assembly comprising:
a housing presenting an inlet for receiving contaminated liquid and an outlet for discharging filtered liquid;
a filter positioned within said housing for filtering said contaminated liquid, wherein said filter is configured to allow the liquid to flow from said inlet through said filter and toward said outlet;
a steam valve coupled with said housing for regulating steam flow into said housing for backwashing said filter without draining said contaminated liquid or said filtered liquid from said housing, wherein said housing is configured to allow said steam to flow from said outlet through said filter to remove contaminants from said filter; and
a drain coupled with said housing and configured for receiving said contaminated liquid, said filtered liquid and said contaminants forced through said drain by said steam.

17. The filter assembly of claim 16, wherein said filter is a metal media filter.

18. The filter assembly of claim 16, wherein said steam valve is coupled with said outlet, and said drain is coupled with said inlet.

19. The filter assembly of claim 16, further comprising an inlet valve coupled with said inlet for regulating the contaminated liquid flow into said housing, an outlet valve coupled with said outlet for regulating the filtered liquid flow out of said housing, and a main drain valve coupled with said drain for regulating the flow through said drain.

20. The filter assembly of claim 16, further comprising:
a plurality of housings each having an inlet and an outlet;
an inlet line coupled with said inlet of each of said housings;
an outlet header line coupled with said outlet of each of said housings;
a backwash drain line coupled with each of said housings; and
a steam inlet line coupled with each of said housings and configured for steam backwashing each of said housings.

21. The filter assembly of claim 20, wherein said backwash drain line is coupled with said inlet of each of said housings, and said steam inlet line is coupled with said outlet of each of said housings.

22. The filter assembly of claim 21, further comprising an inlet valve coupled with said inlet line, an outlet valve coupled with said outlet header line, a main drain valve coupled with said backwash drain line, and a plurality of housing drain valves each coupled with one of said housing inlets.

23. A filter assembly adapted for steam backwashing, said filter assembly comprising:
a housing presenting an inlet for receiving contaminated liquid and an outlet for discharging filtered liquid;
a filter positioned within said housing for filtering said contaminated liquid; and
means for backwashing said filter with steam without draining said contaminated liquid or said filtered liquid from said housing.

24. The filter assembly of claim 23, wherein liquid does not backwash said filter assembly after the steam backwash.
